(19) United States
(12) Patent Application Publication
(10) Pub. No.: US 2017/0265133 A1
(43) Pub. Date: Sep. 14, 2017

(54) INACTIVE COMMUNICATION MODE

(71) Applicant: NOKIA SOLUTIONS AND NETWORKS OY, Espoo (FI)

(72) Inventors: Devaki CHANDRAMOULI, Plano, TX (US); Ingo VIERING, Munich (DE); Frank FREDERIKSEN, Klarup (DK)

(21) Appl. No.: 15/531,790

(22) PCT Filed: Dec. 1, 2014
(86) PCT No.: PCT/US2014/067914

§ 371 Date: May 31, 2017

(51) Int. Cl. H04W 52/02; H04W 76/04; H04W 36/22; H04W 28/02; H04W 76/02; H04W 36/00

(52) U.S. Cl. CPC H04W 52/0216; H04W 52/0212; H04W 52/0241; H04W 76/028; H04W 36/0016; H04W 36/0072; H04W 36/22; H04W 28/0221; H04W 76/046

(57) ABSTRACT

There are provided measures for enabling/realizing an inactive communication mode, namely an inactive mode for the operation of terminal equipment and network equipment in a communication system. Such measures exemplarily comprise operation in a connected mode, in which a data plane connection and a control plane connection are established between a terminal equipment and a network equipment, transition from the connected mode to an inactive mode upon data plane inactivity, and operation in the inactive mode, in which the data plane connection is released and the control plane connection is maintained between the terminal equipment and the network equipment.

### FIELD

The present invention relates to an inactive communication mode. More specifically, the present invention relates to measures (including methods, apparatuses and computer program products) for enabling/realizing an inactive mode for the operation of terminal equipment and network equipment in a communication system.

### BACKGROUND

In mobile communication systems, including 3GPP communication systems beginning from the second generation (2G, 3G, 4G, and beyond), like UMTS, LTE, LTE-A, etc., the operability of terminal equipment and network equipment as well as the operational cooperation there-between is typically defined with reference to predefined modes or states.

For the purpose of the present description, the terms “mode” and “state” are assumed to be basically equivalent to each other. In particular, it is assumed that any equipment can be in a specific mode or state, and could thus be operable in a corresponding mode (of operation). This is assumed for both terminal equipment, such as a user equipment (UE) or a mobile station, and network equipment, such as any network element in a radio access network (RAN), like an eNB or any other base station or access point or controller thereof, or any network element in a core network (CN), like a gateway, a mobility management entity (ME) or the like.

In the current mobile communication systems, mainly two different modes (of operation) are specified, namely connected (or active) mode and idle mode. In LTE/LTE-A, the connected (or active) mode includes ECM-CONNECTED and RRC-CONNECTED, and the idle mode includes ECM-IDLE and RRC-IDLE, for example. As shown in FIG. 1, state transitions are specified between the connected (or active) mode and the idle mode.

From point of view of a cellular radio access network, the basic operability in the connected (or active) mode and the idle mode can be briefly summarized as follows.

In the connected (or active) mode, an UE consumes radio resources and is expected to be actively transmitting data using a user plane connection (via a RRC connection), and is able to communicate (nearly) instantaneously. When there is a change in radio conditions, the UE performs cell reselection, and the RAN is informed of every such cell change. A corresponding handover is mostly network-controlled (unless there is a radio link failure) using the UE context which stored in the RAN. Such network-controlled handover in the connected (or active) mode incurs excessive signaling on both the UE side and the RAN side. In addition, the UE generally consumes significant power in the connected (or active) mode.

In the idle mode, an UE does not consume any radio resources but listens to paging from the network at specific time instants. Thus, the UE consumes less power than in the connected (or active) mode. The UE does not notify the RAN whenever it performs cell reselection, and the UE context is not stored in the RAN. In order for the network to reach the UE (to initiate a MT transaction), it must page the UE, and the UE responds to the paging with a service request or an extended service request. Also, for the UE to initiate a MO transaction, the UE needs to initiate a service request or an extended service request. Such service request or extended service request triggers the establishment of a RRC connection, while it takes some time and also causes extensive signaling on both the UE side and the RAN side to establish both signaling and user plane connections (via a RRC connection).

The idle mode is particularly effective for terminal equipment which does not require network resources, i.e. radio resources for user plane connections, for extended periods of time, especially in view of power consumption. Among such terminal equipment, there are UE(s) with a frequent transmission pattern (e.g. keep alive packets sent and received by applications running on smart phones). Such terminal equipment does not stay in any one of the idle mode and the connected (active) mode for a long period of time, and thus transitions quite frequently between the idle mode and the connected (or active) mode. As outlined above, this results in excessive signaling every time for connection establishment, context transfer, and the like. Furthermore, paging needs to be performed for UE reachability when the UE is in the idle mode. Depending on the paging area, such paging also consumes radio resources.

Accordingly, especially but not exclusively, for such terminal equipment with a frequent transmission pattern, the specified two different modes (of operation) are not appropriate for ensuring efficient operability of terminal equipment and network equipment as well as the operational cooperation there-between, e.g. in terms of both power consumption and incurred signaling load.

A potential approach could be that, for such terminal equipment, use of the idle mode is removed completely and the connected (or active) mode is always used. Such approach is not efficient either. This is essentially because it would require remaining in the connected (or active) mode longer than necessary, which will cause more power consumption for the terminal equipment and could also result in higher signaling load, especially for highly mobile devices due to the necessity of performing handovers in the connected (or active) mode. In scenarios with a high number/density of RAN elements and/or devices, such as in a stadium, concert, soccer game, or airport/station scenario, it would be an overkill for each device to notify the respective base station or access point whenever it enters the coverage area of the new cell, and notification to the network upon each cell change can simply overload the network.

Accordingly, there is a demand for enabling/realizing efficient operability of terminal equipment and network equipment as well as the operational cooperation there-between, e.g. in terms of both power consumption and incurred signaling load, in a communication system.

### SUMMARY

Various exemplifying embodiments of the present invention aim at addressing at least part of the above issues and/or problems and drawbacks.

Various aspects of exemplifying embodiments of the present invention are set out in the appended claims.

According to an example aspect of the present invention, there is provided a method comprising operating in a connected mode, in which a data plane connection and a control plane connection are established between a terminal equipment and a network equipment, for processing communication with the network equipment, transitioning from the connected mode to an inactive mode upon data plane inactivity, and operating in the inactive mode, in which the data plane connection is released and the control plane connection is maintained between the terminal equipment and the network equipment, for processing communication with the network equipment.

According to an example aspect of the present invention, there is provided a method comprising operating in a connected mode, in which a data plane connection and a control plane connection are established between a terminal equipment and a network equipment and context information for the terminal equipment is established, for processing communication with the terminal equipment, transitioning from the connected mode to an inactive mode upon data plane inactivity, and operating in the inactive mode, in which the data plane connection is released and the control plane connection is maintained between the terminal equipment and the network equipment and the context information for the terminal equipment is maintained, for processing communication with the terminal equipment.

According to an example aspect of the present invention, there is provided an apparatus comprising a processor, and a memory configured to store computer program code, wherein the processor is configured to cause the apparatus to perform: operating in a connected mode, in which a data plane connection and a control plane connection are established between a terminal equipment and a network equipment, for processing communication with the network equipment, transitioning from the connected mode to an inactive mode upon data plane inactivity, and operating in the inactive mode, in which the data plane connection is released and the control plane connection is maintained between the terminal equipment and the network equipment, for processing communication with the network equipment.

According to an example aspect of the present invention, there is provided an apparatus comprising a processor, and a memory configured to store computer program code, wherein the processor is configured to cause the apparatus to perform: operating in a connected mode, in which a data plane connection and a control plane connection are established between a terminal equipment and a network equipment and context information for the terminal equipment is established, for processing communication with the terminal equipment, transitioning from the connected mode to an inactive mode upon data plane inactivity, and operating in the inactive mode, in which the data plane connection is released and the control plane connection is maintained between the terminal equipment and the network equipment and the context information for the terminal equipment is maintained, for processing communication with the terminal equipment.

According to an example aspect of the present invention, there is provided an apparatus comprising means for operating in a connected mode, in which a data plane connection and a control plane connection are established between a terminal equipment and a network equipment, for processing communication with the network equipment, means for transitioning from the connected mode to an inactive mode upon data plane inactivity, and means for operating in the inactive mode, in which the data plane connection is released and the control plane connection is maintained between the terminal equipment and the network equipment, for processing communication with the network equipment.

According to an example aspect of the present invention, there is provided an apparatus comprising means for operating in a connected mode, in which a data plane connection and a control plane connection are established between a terminal equipment and a network equipment and context information for the terminal equipment is established, for processing communication with the terminal equipment, means for transitioning from the connected mode to an inactive mode upon data plane inactivity, and means for operating in the inactive mode, in which the data plane connection is released and the control plane connection is maintained between the terminal equipment and the network equipment and the context information for the terminal equipment is maintained, for processing communication with the terminal equipment.

According to an example aspect of the present invention, there is provided a computer program product comprising computer-executable computer program code which, when the program code is executed (or run) on a computer or the program is run on a computer (e.g. a computer of an apparatus according to any one of the aforementioned apparatus-related example aspects of the present invention), is configured to cause the computer to carry out the method according to any one of the aforementioned method-related example aspects of the present invention.

The computer program product may comprise or may be embodied as a (tangible/non-transitory) computer-readable (storage) medium or the like, on which the computer-executable computer program code is stored, and/or the program is directly loadable into an internal memory of the computer or a processor thereof.

Further developments and/or modifications of the aforementioned exemplary aspects of the present invention are set out in the following. By way of exemplifying embodiments of the present invention, an inactive mode for the operation of terminal equipment and network equipment in a communication system can be enabled/realized. The inactive mode according to exemplifying embodiments of the present invention can be (logically) classified in-between the conventionally specified modes, i.e. the idle mode and the connected (active) mode, from a functional or operational perspective.

By the inactive mode according to exemplifying embodiments of the present invention, efficient operability of terminal equipment and network equipment as well as the operational cooperation there-between, e.g. in terms of both power consumption and incurred signaling load, in a communication system can be enabled/realized.

### BRIEF DESCRIPTION OF THE DRAWINGS

In the following, the present invention will be described in greater detail by way of non-limiting examples with reference to the accompanying drawings, in which

FIG. 1 shows a schematic diagram illustrating conventional states and state transitions of a connected (or active) mode and an idle mode,

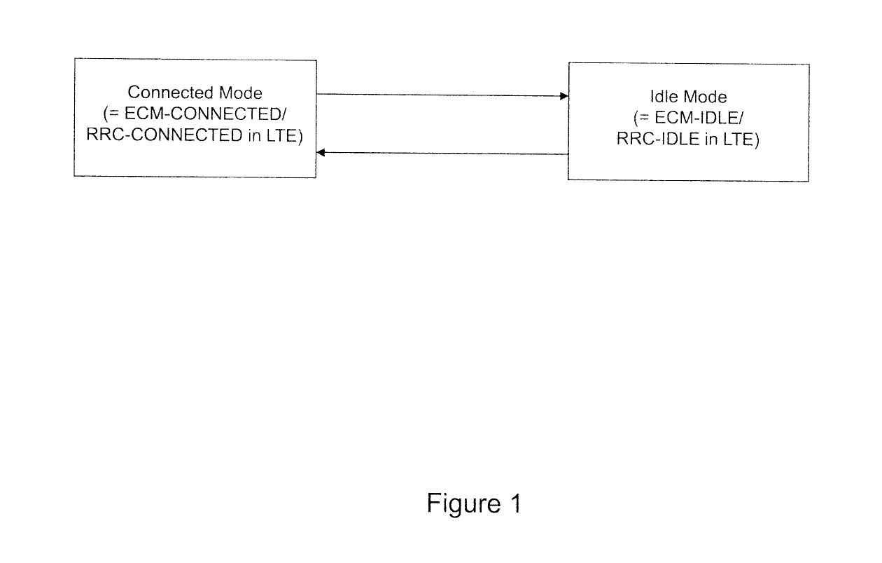

FIG. 2 shows a schematic diagram illustrating a generic example of states and state transitions of a connected (or active) mode, an idle mode and an inactive/semi-connected mode according to exemplifying embodiments of the present invention,

FIG. 3 shows a flowchart illustrating a method of operation with a connected (or active) mode, an idle mode and an inactive/semi-connected mode according to exemplifying embodiments of the present invention,

FIG. 4 shows a schematic diagram illustrating a specific example of states and state transitions of a connected (or active) mode, an idle mode and an inactive/semi-connected mode according to exemplifying embodiments of the present invention,

FIG. 5 shows a schematic diagram illustrating an example of a procedure in a system configuration according to exemplifying embodiments of the present invention,

FIG. 6 shows a schematic diagram illustrating another example of a procedure in a system configuration according to exemplifying embodiments of the present invention,

FIG. 7 shows a schematic diagram illustrating an example of a structure of apparatuses according to exemplifying embodiments of the present invention, and

FIG. 8 shows a schematic diagram illustrating another example of a structure of apparatuses according to exemplifying embodiments of the present invention.

### DETAILED DESCRIPTION

The present invention is described herein with reference to particular non-limiting examples and to what are presently considered to be conceivable embodiments of the present invention. A person skilled in the art will appreciate that the present invention is by no means limited to these examples and embodiments, and may be more broadly applied.

It is to be noted that the following description of the present invention and its embodiments mainly refers to specifications being used as non-limiting examples for certain exemplifying network configurations and system deployments. Namely, the present invention and its embodiments are mainly described in relation to 3GPP specifications being used as non-limiting examples. As such, the description of exemplifying embodiments given herein specifically refers to terminology which is directly related thereto. Such terminology is only used in the context of the presented non-limiting examples and embodiments, and does naturally not limit the invention in any way. Rather, any other system configuration or deployment may equally be utilized as long as complying with what is described herein and/or exemplifying embodiments described herein are applicable to it.

Hereinafter, various exemplifying embodiments and implementations of the present invention and its aspects are described using several variants and/or alternatives. It is generally to be noted that, according to certain needs and constraints, all of the described variants and/or alternatives may be provided alone or in any conceivable combination (also including combinations of individual features of the various variants and/or alternatives). In this description, the words “comprising” and “including” should be understood as not limiting the described exemplifying embodiments and implementations to consist of only those features that have been mentioned, and such exemplifying embodiments and implementations may also contain features, structures, units, modules etc. that have not been specifically mentioned.

In the drawings, it is to be noted that lines/arrows interconnecting individual blocks or entities are generally meant to illustrate an operational coupling there-between, which may be a physical and/or logical coupling, which on the one hand is implementation-independent (e.g. wired or wireless) and on the other hand may also comprise an arbitrary number of intermediary functional blocks or entities not shown. For sake of clarity and lucidity, all of the exemplary network system configurations and structures are illustrated in a simplified manner.

According to exemplifying embodiments of the present invention, in general terms, there are provided measures and mechanisms for enabling/realizing an inactive mode for the operation of terminal equipment and network equipment in a communication system.

In the following, the conventionally specified modes are denoted as connected mode and idle mode, while the mode according to exemplifying embodiments of the present invention is mainly denoted as inactive mode/semi-connected mode. It is noted that such denomination of the mode according to exemplifying embodiments of the present invention is by no way restrictive or limiting, but intends to reflect its basic characteristics with regard to the conventionally specified modes, namely its (logical) classification in-between the conventionally specified modes from a functional or operational perspective. Insofar, the mode according to exemplifying embodiments of the present invention can equally be denoted as inactive mode, inactive connected mode, semi-connected mode, semi-connected idle mode, or the like.

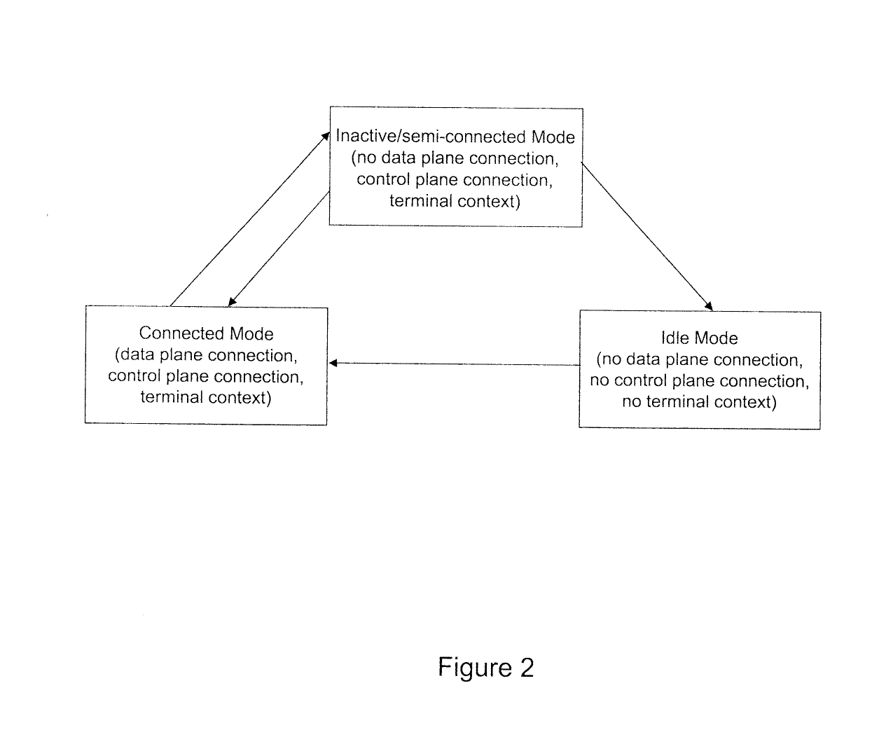

FIG. 2 shows a schematic diagram illustrating a generic example of states and state transitions of a connected (or active) mode, an idle mode and an inactive/semi-connected mode according to exemplifying embodiments of the present invention.

As shown in FIG. 2, a connected mode, an idle mode and an inactive/semi-connected mode are specified according to exemplifying embodiments of the present invention. Basically, any network equipment may be operable in any one of these modes. Specifically, a terminal equipment, such as a user equipment (UE) or a mobile station, and/or a network equipment in a radio access network (RAN), like an eNB or any other base station or access point or controller thereof, may be operable in any one of these modes, respectively.

In the connected mode, a data plane connection between the terminal equipment and the network equipment and a control plane connection between the terminal equipment and the network equipment are established, and a terminal equipment context is established at the network equipment. In the inactive/semi-connected mode, the data plane connection between the terminal equipment and the network equipment is released and the control plane connection between the terminal equipment and the network equipment is maintained, and the terminal equipment context is maintained at the network equipment. Further, in the inactive mode, less radio resources may be allocated for communication than in the connected mode. Namely, limited radio resources may be allocated for uplink and/or downlink communication between the terminal equipment and the network equipment in the inactive mode. In the idle mode, the data plane connection between the terminal equipment and the network equipment and the control plane connection between the terminal equipment and the network equipment are released, and the terminal equipment context is removed from the network equipment.

Between the individual modes, a transition from the connected mode to the inactive/semi-connected mode is enabled, a transition from the inactive/semi-connected mode to the connected mode is enabled, a transition from the inactive/semi-connected mode to the idle mode is enabled, and a transition from the idle mode to the connected mode is enabled.

That is, a method according to exemplifying embodiments of the present invention, which may be implemented/realized at a terminal equipment and/or a network equipment, comprises an operation in the connected mode, e.g. after establishment of a data plane connection and a user connection between a terminal equipment and a network equipment, a transition from the connected mode to the inactive/semi-connected mode, e.g. upon data plane inactivity, and an operation in the inactive/semi-connected mode. Further, such method may further comprise a transition from the inactive/semi-connected mode to the connected mode, e.g. upon actual or prospective data plane activity, and an operation in the connected mode. Alternatively, such method may further comprise a transition from the inactive/semi-connected mode to the idle mode, e.g. upon control plane inactivity, and an operation in the idle mode. Finally, such method may further comprise a transition from the idle mode to the connected mode, e.g. upon actual or prospective data plane activity, and an operation in the connected mode.

Accordingly, transitions from the connected mode to the idle mode pass through the inactive/semi-connected mode. From the inactive/semi-connected mode, it is possible to directly return to the connected mode without passing through the idle mode. From the idle mode, it is possible to directly return to the connected mode without passing through the inactive/semi-connected mode. Thereby, according to exemplifying embodiments of the present invention, when a terminal and/or network equipment leaves the connected mode, it enters the inactive/semi-connected mode (rather than the idle mode), where less power is consumed than in the connected mode (e.g. due to allocation/consumption of fewer radio resource), while ensuring quick reachability and connection re-/establishment ability (e.g. due to maintenance of the terminal equipment context).

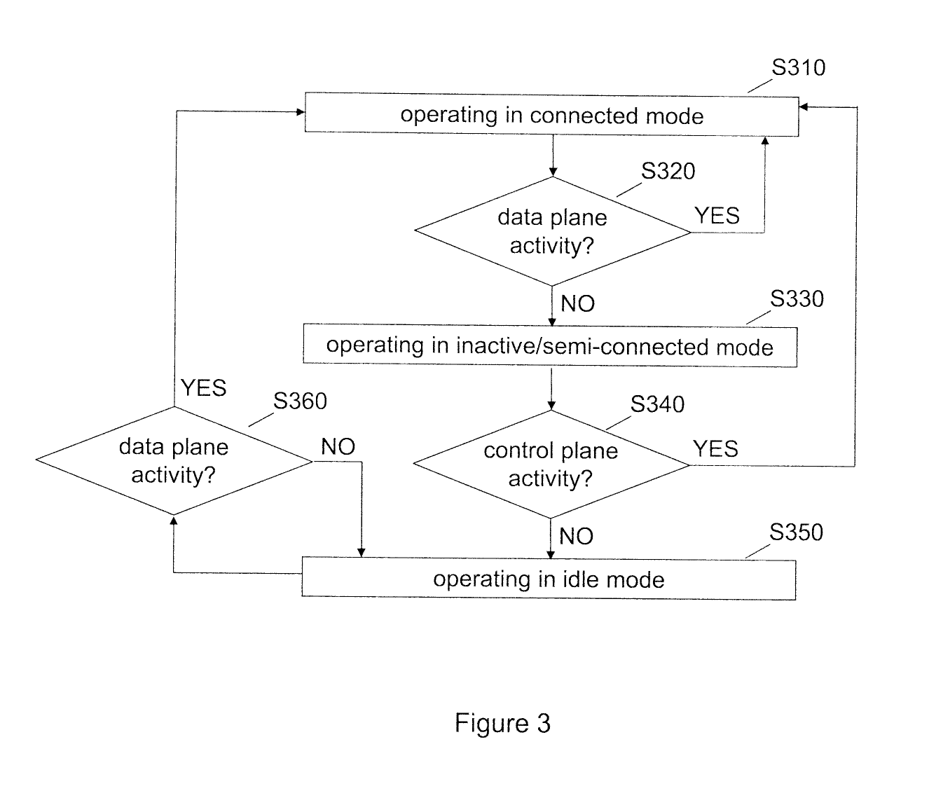

FIG. 3 shows a flowchart illustrating a method of operation with a connected (or active) mode, an idle mode and an inactive/semi-connected mode according to exemplifying embodiments of the present invention. The thus illustrated method may be implemented/realized at a terminal equipment and/or a network equipment.

As shown in FIG. 3, a method according to exemplifying embodiments of the present invention comprises a function (S310) of operating in a connected mode, e.g. after establishment of a data plane connection and a user connection between a terminal equipment and a network equipment. Further, such method comprises a function of transitioning from the connected mode to the inactive/semi-connected mode, which may be conducted upon data plane inactivity, and a function (S330) of operating in the inactive/semi-connected mode. To this end, such method comprises a function (S320) of detecting data plane in-/activity, wherein data plane inactivity is detected when no communication of data plane traffic on the data plane connection is present for a data plane inactivity period.

As shown in FIG. 3, a method according to exemplifying embodiments of the present invention may further comprise a function of transitioning from the inactive/semi-connected mode to the idle mode, which may be conducted upon control plane inactivity, and a function (S350) of operating in the idle mode. To this end, such method may comprise a function (S340) of detecting control plane in-/activity, wherein control plane inactivity is detected when no communication of control plane traffic on the control plane connection is present for a control plane inactivity period.

As shown in FIG. 3, a method according to exemplifying embodiments of the present invention may further comprise a function of transitioning from the idle mode to the connected mode, which may be conducted upon actual or prospective data plane activity, thus returning to the function (S310) of operating in the connected mode. To this end, such method may comprise a function (S360) of detecting actual or prospective data plane in-/activity, wherein upon actual or prospective data plane activity is detected when re-establishment of the data plane connection is initiated or requested (by the terminal equipment or the network equipment), or when data plane traffic requiring re-establishment of the data plane connection is pending (at the terminal equipment).

Generally, respective operations in the connected mode, the inactive/semi-connected mode and the idle mode serve for processing communication between the terminal equipment and the network equipment, respectively. For processing communication with the network equipment, a respective mode may be operated/realized in the terminal equipment and/or a core network element. For processing communication with the terminal equipment, a respective mode may be operated/realized in the terminal equipment acting as a radio access network element.

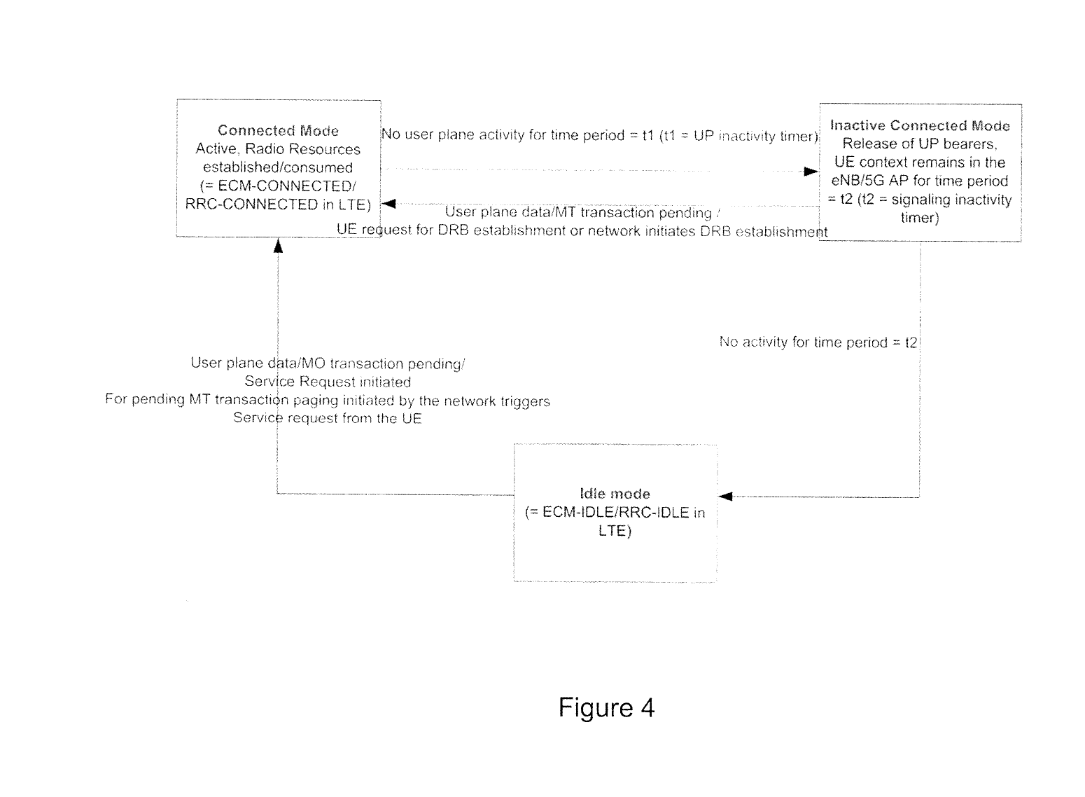

While such communication processing is mainly based on specified operability and operational cooperation in the connected mode and the idle mode, details of exemplary operability and operational cooperation in the inactive/semi-connected mode are outlined with reference to FIGS. 4 to 6 below.

In the following, various examples of operability of and operational cooperation between a terminal equipment and a network equipment according to exemplifying embodiments of the present invention are given, wherein a LTE/LTE-A (4G) or 5G communication system is adopted as a non-limiting underling system deployment. Specifically, a terminal equipment is exemplified as a user equipment (UE), a network equipment is exemplified by a RAN element such as an eNB in LTE/LTE-A or a 5G AP, the connected mode is exemplified as ECM-CONNECTED/RRC-CONNECTED, and the idle mode is exemplified as ECM-IDLE/RRC-IDLE. Further, the data plane connection is exemplified as a user plane connection, particularly user plane bearers between the UE and the RAN element, and the control plane connection is exemplified as signaling connection comprising at least a RRC connection between the UE and the RAN element (and, potentially, also a S1 connection between the RAN element and a CN element such as a GW or MME).

FIG. 4 shows a schematic diagram illustrating a specific example of states and state transitions of a connected (or active) mode, an idle mode and an inactive/semi-connected mode according to exemplifying embodiments of the present invention.

In the connected mode, UP bearers and a (ECM/RRC) signaling connection are established between the UE and the RAN element, and radio resources are established/consumed such that a communication is active. Also, a (S1) signaling connection is established between the RAN element and a CN element (i.e. MME/GW) in the connected mode. When no user plane activity is detected for a predetermined time period (t1) set as/in a UP inactivity timer (i.e. a data plane inactivity period), transition to the inactive connected mode is caused at the UE and/or the RAN element. In this regard, UP bearers between the UE and the RAN element are released, while the (ECM/RRC) signaling connection between the UE and the RAN element (or, at least, a signaling connectivity or UE reachability from the RAN element) is maintained. Further, the UE context at the RAN element, which has been established in the connected mode, e.g. upon establishment of the user/control plane connection, is maintained at the RAN element. The (S1) signaling connection between the RAN element and the CN element (i.e. MME/GW) can either be maintained or released in the inactive connected mode.

In the inactive connected mode, when no signaling activity is detected for a predetermined time period (t2) set as/in a signaling inactivity timer (i.e. a control plane inactivity period), transition to the idle mode is caused at the UE and/or the RAN element. In this regard, the (ECM/RRC) signaling connection between the UE and the RAN element is released, and the (S1) signaling connection between the RAN element and the CN element is also released. Further, the UE context at the RAN element, which has been established in the connected mode, e.g. upon establishment of the user/control plane connection, is removed.

In the inactive connected mode, when actual or prospective user plane activity is detected within the predetermined time period (t2) set as/in a signaling inactivity timer (i.e. a control plane inactivity period), transition to the connected mode is caused at the UE and/or the RAN element. In this regard, UP bearers between the UE and the RAN element are re-established using the maintained (ECM/RRC) signaling connection (or, at least, signaling connectivity or UE reachability) there-between and the UE context maintained at the RAN element. As there is a maintained (ECM/RRC) signaling connection (or, at least, signaling connectivity or UE reachability) between the UE and the RAN element and a UE context maintained at the RAN element, only re-establishment of UP bearers is required in the inactive connected mode, which incurs no or only few signaling load and takes not much time.

In the inactive connected mode, the actual or prospective user plane activity can comprise any user plane traffic to be communicated in the uplink and/or downlink direction between the UE and the RAN element when re-establishment of UP bearers is initiated or requested by the UE or the RAN element, or when user plane traffic requiring re-establishment of UP bearers is pending at the UE. For example, pending MO transaction (i.e. user plane data) at the UE and/or pending MT transaction (i.e. user plane data) at the RAN element can represent actual or prospective user plane activity. Also, actual or prospective user plane activity can be represented by a UE request for DRB establishment or a network initiation of DRB establishment. As the UE context is maintained in the RAN element, no paging, service request or extended service request is required for reachability between the UE and the RAN element.

In the idle mode, when actual or prospective data plane activity is detected, transition to the connected mode is caused at the UE and/or the RAN element. In this regard, UP bearers between the UE and the RAN element are re-established. As there is no maintained (ECM/RRC) signaling connection (or, at least, signaling connectivity or UE reachability) between the UE and the RAN element (and there is no maintained (S1) signaling connection between the RAN element and the CN element) and no UE context maintained at the RAN element, re-establishment of a signaling connection as well as re-establishment of UP bearers are required in the idle mode, which incurs higher signaling load and takes a longer time than UP bearer re-establishment from the inactive connected mode.

In the idle mode, the actual or prospective user plane activity can comprise any user plane traffic to be communicated in the uplink and/or downlink direction between the UE and the RAN element when re-establishment of UP bearers is initiated or requested by the UE or the RAN element, or when user plane traffic requiring re-establishment of UP bearers is pending at the UE. For example, pending MO transaction (i.e. user plane data) at the UE and/or pending MT transaction (i.e. user plane data) at the RAN element can represent actual or prospective user plane activity. For the network to reach the UE (to initiate a MT transaction), it must page the UE and the UE responds to the paging with a service request or an extended service request. Also, for the UE to initiate a MO transaction, the UE needs to initiate a service request or an extended service request. Such service request or extended service request triggers the establishment of a RRC connection between the UE and the RAN element.

According to exemplifying embodiments of the present invention, the predetermined time period (t1) set as/in the UP inactivity timer (i.e. a data plane inactivity period) and/or the predetermined time period (t2) set as/in the signaling inactivity timer (i.e. a control plane inactivity period) can be determined by the network, e.g. based on the UE's transmission and/or behavior pattern (i.e. traffic and/or mobility pattern), or can be negotiated between the UE and the network, e.g. during initial connection establishment. The predetermined time period (t1) set as/in the UP inactivity timer (i.e. a data plane inactivity period) and/or the predetermined time period (t2) set as/in the signaling inactivity timer (i.e. a control plane inactivity period) can specifically determined such that specific kinds of terminal equipment, like devices with a frequent transmission pattern, transition to and remain in the inactive connected mode (and do not transition to the idle mode) between two subsequent transmissions (e.g. the periodic sending of keep alive packets every 60 to 90 seconds or so).

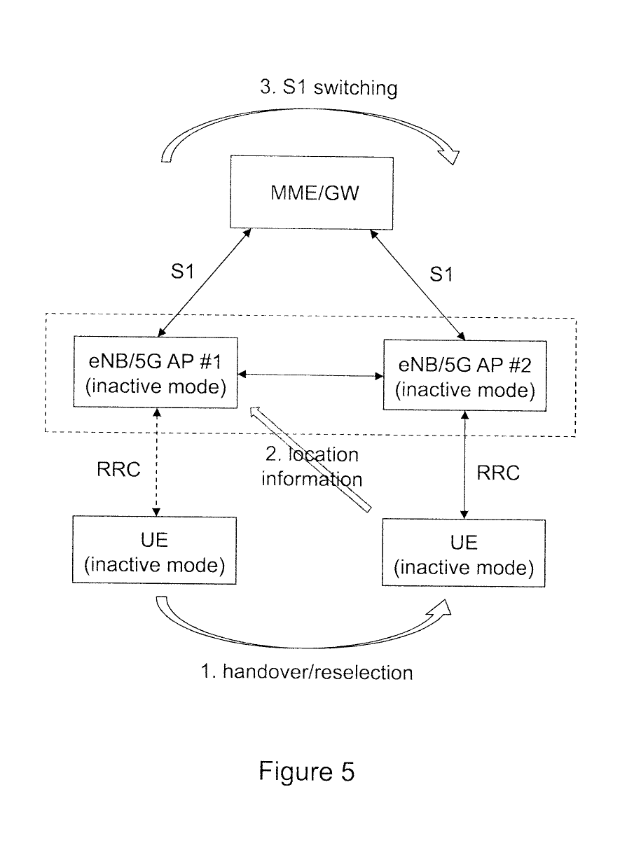

FIG. 5 shows a schematic diagram illustrating an example of a procedure in a system configuration according to exemplifying embodiments of the present invention.

In the system configuration of FIG. 5, it is assumed that two RAN elements, i.e. eNB/5G AP #1 and eNB/5G AP #2, belong to a cluster or cluster area (as indicated by a dashed block), where it is possible for the UE to remain in the in the inactive mode, while still having the possibility for efficient re-connection to the network (with no or only few signaling load in a short time).

In the procedure of FIG. 5, a RRC connection has been established between the UE and the first RAN element (i.e. eNB/5G AP #1), and a connection (including at least a S1 connection) has been established between the first RAN element and the CN element (i.e. MME/GW). That is, the UE and the first RAN element have been in the connected mode, but have then transitioned to the inactive mode. Accordingly, the RRC connection (i.e. the data/user plane connection) is released (as indicated by a dashed double-arrow). In the inactive mode, the UE performs handover or (cell) reselection, e.g. due to mobility or changing radio conditions, from the first RAN element to the second RAN element within the same cluster or cluster area, while remaining in the in the inactive mode. The UE context still remains in the first RAN element, where it has been maintained in transitioning from the connected mode to the inactive mode.

Upon performing handover or (cell) reselection to the second RAN element, the UE then notifies the first RAN element accordingly. Namely, the UE may be configured to provide information indicative of at least one of location and serving RAN element, i.e. the second RAN element, of the UE to the old RAN element, i.e. the first RAN element, within the same cluster or cluster area (denoted as “location information”). That is, the old RAN element, i.e.

the first RAN element (which still maintains the UE context), within the same cluster or cluster area may be configured to track the “location information” of the UE, i.e. the information indicative of at least one of location and serving RAN element, i.e. the second RAN element. As the network is informed every time the UE changes a cell or serving RAN element, paging is not necessary for the network to reach the UE.

In the procedure of FIG. 5, it is assumed that, in the inactive mode, the connection between the serving RAN element and the CN element is maintained (or, kept active), which may include the data/user plane connection and/or the control plane connection which have been established during a preceding connected mode. Accordingly, upon the handover or (cell) reselection of the UE, the maintained connection can be switched from the first RAN element to the second RAN element (and, in case a different CN element is assigned for the second RAN element, also to the new CN element).

That is, when the S1 connection is maintained (or, kept active), a S1 path switch can be performed (by the first RAN element). However, when the network needs to transmit downlink data to the UE, it does not need to page the UE, and a re-connection time will thus be faster (as no service request or extended service request is necessary). When multiple connections between a RAN element and a CN element are established (including multiple data/user plane connections (such as UP bearers) and/or multiple control plane connections (such as S1 connections)), like e.g. in 5G systems, all of these multiple connections can be switched and handled in case of handover or (cell) reselection.

Thus, while being in the inactive mode, a RRC connection is established between the UE and the second RAN element, and a S1 connection is established between the second RAN element and the CN element (as indicated by solid double-arrows).

On the other hand, it may be the case that, in the inactive mode, the connection between the serving RAN element and the CN element is released, which may include the data/user plane connection and/or the control plane connection which have been established during a preceding connected mode. Accordingly, upon the handover or (cell) reselection of the UE, a new connection is established between the second RAN element and the CN element (and, in case a different CN element is assigned for the second RAN element, to a new CN element).

That is, when the S1 connection is not maintained, a S1 path switch is not necessary (by the first RAN element). However, when the network needs to transmit downlink data to the UE, it needs to page the UE, and a re-connection time will thus be slower (as a service request or extended service request is necessary). In such case, the UE context should be transferred/shifted to the new RAN element already during handover or (cell) reselection, thus being maintained at the new RAN element in the inactive mode.

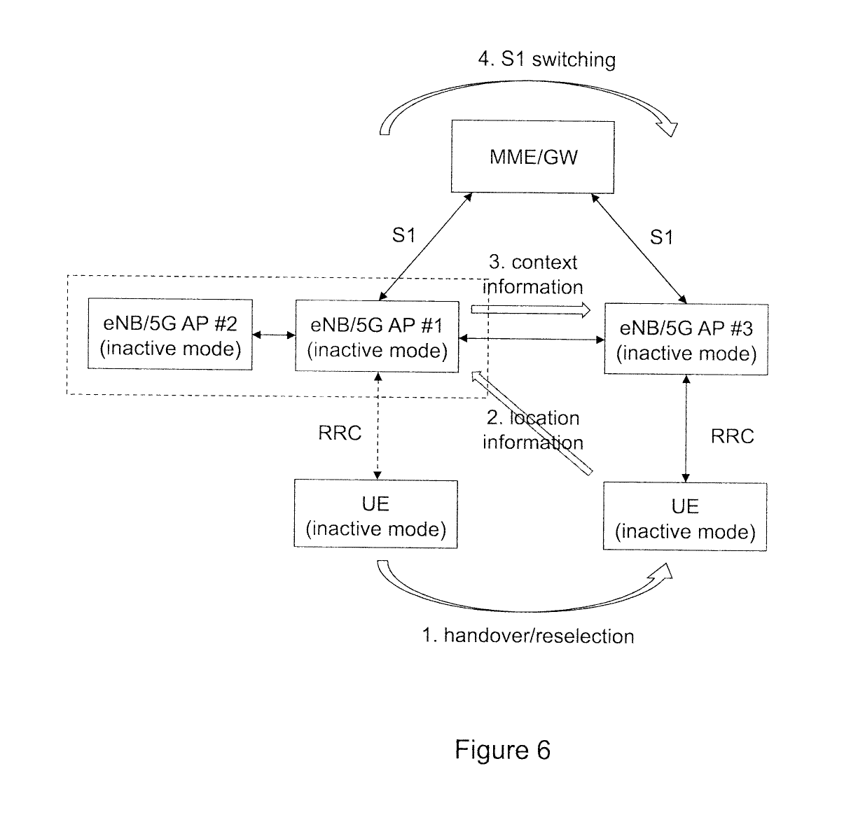

FIG. 6 shows a schematic diagram illustrating another example of a procedure in a system configuration according to exemplifying embodiments of the present invention.

In the system configuration of FIG. 6, it is assumed that two RAN elements, i.e. eNB/5G AP #1 and eNB/5G AP #2, belong to a cluster or cluster area (as indicated by a dashed block), where it is possible for the UE to remain in the in the inactive mode, while still having the possibility for efficient re-connection to the network (with no or only few signaling load in a short time), whereas another RAN element, i.e. eNB/5G AP #3, does not belong to the same cluster or cluster area.

In the procedure of FIG. 6, a RRC connection has been established between the UE and the first RAN element (i.e. eNB/5G AP #1), and a connection (including at least a S1 connection) has been established between the first RAN element and the CN element (i.e. MME/GW). That is, the UE and the first RAN element have been in the connected mode, but have then transitioned to the inactive mode. Accordingly, the RRC connection (i.e. the data/user plane connection) is released (as indicated by a dashed double-arrow). In the inactive mode, the UE performs handover or (cell) reselection, e.g. due to mobility or changing radio conditions, from the first RAN element to the third RAN element not within the same cluster or cluster area, while remaining in the in the inactive mode.

Upon performing handover or (cell) reselection to the second RAN element, the UE then notifies the first RAN element accordingly, and the first RAN element thus tracks the UE, as described in connection with FIG. 5 above.

Then, the UE context has to be transferred/shifted from the first RAN element, where it has been maintained in transitioning from the connected mode to the inactive mode, to the third RAN element. Such transfer/shift of the UE context can be performed upon handover or (cell) reselection, i.e. already when the serving RAN element of the UE changes, or only when establishment of a new user/data plane connection (i.e. UP bearers) between the UE and the recent third RAN element is required.

The handling of the connection between the RAN element/s and the CN element/s is similar to that described for FIG. 5, and thus reference is made to the above description.

According to exemplifying embodiments of the present invention, the UE may enter the inactive mode with some limited radio resources allocated (irrespective of their actual usage). This may apply to uplink and/or downlink. If so, the UE may have some “beacon channels” or the like to use for the two link directions.

As described above, when the UE in the inactive mode moves into the coverage area of another cell (i.e. base station, access point, transmission point, etc.) while being still located in the RAN (or in (the domain of) a RAN controller), the network is able to “track” the location of the UE. Possibilities for the tracking could be based on either the UE transmitting occasional beacon signals for base station tracking of given UEs, or the UE being mandated/configured to transmit a simple ping or the like towards the new base station that has better coverage for the UE. Both approaches have less signaling load compared to traditional tracking area updates in the idle mode.

The way the RAN can handle the moving UE could be based on context pointers, where the last used RAN element keeps the UE context until it is actually needed by another RAN element. If a UE is updating its location to a new RAN element, the old RAN element can be informed (by the UE or the new RAN element) that there is a potential target RAN element, and only in case the UE needs to have an active connection, the UE context is shifted to the new target RAN element. Thereby, it is possible to reduce the network signaling to transfer/shift the UE context within the radio access network, while obtaining at least some of the benefits of having a UE loosely connected to the network within a larger coverage area.

As evident from the description of FIGS. 5 and 6, a terminal equipment can perform handover or (cell) reselection in an autonomous manner. Thus, radio resources involved can be minimized, as it is sufficient to (shortly) inform the network rather than engaging the network in the actual process of handover or (cell) reselection.

By virtue of exemplifying embodiments of the present invention, as evident from the above, an inactive mode for the operation of terminal equipment and network equipment in a communication system can be enabled/realized. The inactive mode according to exemplifying embodiments of the present invention can be (logically) classified in-between the conventionally specified modes, i.e. the idle mode and the connected (active) mode, from a functional or operational perspective.

Generally, the inactive mode according to exemplifying embodiments of the present invention can be regarded as an operation mode of a single equipment, such as a state of the terminal equipment and/or the network equipment, or an operation mode between the terminal equipment and the network equipment (the individual equipments are typically in the same state, respectively).

With the inactive mode according to exemplifying embodiments of the present invention, the terminal equipment does not directly transition to the idle mode. Thus, the number and frequency of transitions to and from the idle mode, which are typically rather inefficient, is reduced.

With the inactive mode according to exemplifying embodiments of the present invention, reconnection of a terminal equipment with a network equipment can be accomplished fast (e.g. within 10 milliseconds) and without requiring any/much network signaling. This is essentially because the terminal equipment in the inactive mode remains reachable for the network equipment, thus not requiring paging and/or initiation of a service request or an extended service request for reconnection. That is, the number of paging messages and thus the usage of paging resources can be reduced, thereby reducing the time taken and the signaling incurred due to frequent transitions from the idle mode to the connected mode.

Further, when the terminal equipment remains the inactive mode, its context information is maintained in the (radio access) network such that there is not need to retrieve such context information from the core network. The context information generally refer to information being associated with a specific terminal equipment, which are held in the radio access network, and which contain information required to maintain the radio access network services towards the active terminal equipment, such as state information, security information, capability information and identities of the terminal-associated logical (S1) connection/s.

Accordingly, the inactive mode according to exemplifying embodiments of the present invention facilitates efficient operability of terminal equipment and network equipment as well as the operational cooperation there-between, e.g. in terms of both power consumption and incurred signaling load, in a communication system.

The inactive mode according to exemplifying embodiments of the present invention is applicable in any system configuration in which a terminal equipment and a network equipment are operable and cooperative on the basis of predefined modes or states, including the conventionally specified idle mode and connected (active) modes. Applicability is neither restricted to any specific technology are network specification, nor to any specific terminal or network equipment.

The above-described methods, procedures and functions may be implemented by respective functional elements, entities, modules, units, processors, or the like, as described below.

While in the foregoing exemplifying embodiments of the present invention are described mainly with reference to methods, procedures and functions, corresponding exemplifying embodiments of the present invention also cover respective apparatuses, entities, modules, units, network nodes and/or systems, including both software and/or hardware thereof.

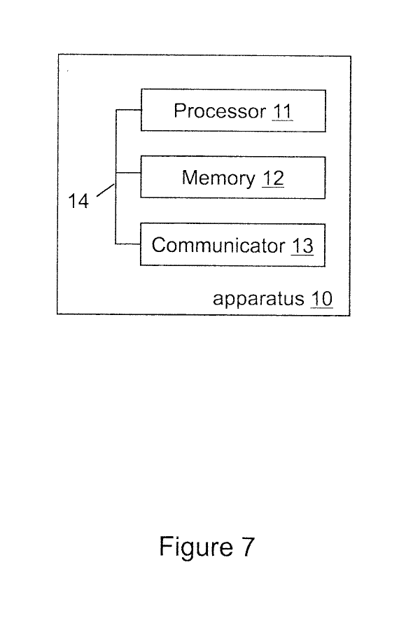

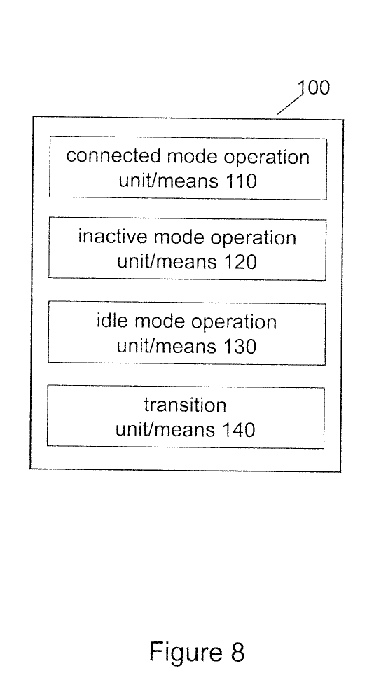

Respective exemplifying embodiments of the present invention are described below referring to FIGS. 7 and 8, while for the sake of brevity reference is made to the detailed description of respective corresponding configurations/setups, schemes, methods and functionality, principles and operations according to FIGS. 2 to 6.

In FIGS. 7 and 8, the blocks are basically configured to perform respective methods, procedures and/or functions as described above. The entirety of blocks are basically configured to perform the methods, procedures and/or functions as described above, respectively. With respect to FIGS. 7 and 8, it is to be noted that the individual blocks are meant to illustrate respective functional blocks implementing a respective function, process or procedure, respectively. Such functional blocks are implementation-independent, i.e. may be implemented by means of any kind of hardware or software or combination thereof, respectively.

Further, in FIGS. 7 and 8, only those functional blocks are illustrated, which relate to any one of the above-described methods, procedures and/or functions. A skilled person will acknowledge the presence of any other conventional functional blocks required for an operation of respective structural arrangements, such as e.g. a power supply, a central processing unit, respective memories or the like. Among others, one or more memories are provided for storing programs or program instructions for controlling or enabling the individual functional entities or any combination thereof to operate as described herein in relation to exemplifying embodiments.

FIG. 7 shows a schematic diagram illustrating an example of a structure of apparatuses according to exemplifying embodiments of the present invention.

As indicated in FIG. 7, according to exemplifying embodiments of the present invention, an apparatus 10 may comprise at least one processor 11 and at least one memory 12 (and possibly also at least one communicator 13), which may be operationally connected or coupled, for example by a bus 14 or the like, respectively.

The processor 11 and/or the communicator 13 of the apparatus 10 may also include a modem or the like to facilitate communication over a (hardwire or wireless) link, respectively. The communicator 13 of the apparatus 10 may include a suitable transmitter, receiver or transceiver connected or coupled to one or more antennas, antenna units, such as antenna arrays or communication facilities or means for (hardwire or wireless) communications with the linked, coupled or connected device(s), respectively. The communicator 13 of the apparatus 10 is generally configured to communicate with at least one other apparatus, device, node or entity (in particular, the communicator thereof).

The memory 12 of the apparatus 10 may represent a (non-transitory/tangible) storage medium and store respective software, programs, program products, macros or applets, etc. or parts of them, which may be assumed to comprise program instructions or computer program code that, when executed by the respective processor, enables the respective electronic device or apparatus to operate in accordance with the exemplifying embodiments of the present invention. Further, the memory 12 of the apparatus 10 may (comprise a database to) store any data, information, or the like, which is used in the operation of the apparatus.

In general terms, respective apparatuses (and/or parts thereof) may represent means for performing respective operations and/or exhibiting respective functionalities, and/or the respective devices (and/or parts thereof) may have functions for performing respective operations and/or exhibiting respective functionalities.

In view of the above, the thus illustrated apparatus 10 is suitable for use in practicing one or more of the exemplifying embodiments of the present invention, as described herein.

When in the subsequent description it is stated that the processor (or some other means) is configured to perform some function, this is to be construed to be equivalent to a description stating that a (i.e. at least one) processor or corresponding circuitry, potentially in cooperation with a computer program code stored in the memory of the respective apparatus or otherwise available (it should be appreciated that the memory may also be an external memory or provided/realized by a cloud service or the like), is configured to cause the apparatus to perform at least the thus mentioned function.

On the one hand, the thus illustrated apparatus 10 may represent or realize/embody a (part of a) terminal equipment. Specifically, the thus illustrated apparatus 10 may be configured to perform a procedure and/or exhibit a functionality and/or implement a state diagram, as described, for the terminal equipment, in any one of FIGS. 2 to 6.

Accordingly, the apparatus 10 may be caused or the apparatus 10 or its processor 11 (possibly together with computer program code stored in the memory 12), in its most basic form, is configured to operate in a connected mode, in which a data plane connection and a control plane connection are established between a terminal equipment and a network equipment, for processing communication with the network equipment, to transition from the connected mode to an inactive mode upon data plane inactivity, and to operate in the inactive mode, in which the data plane connection is released and the control plane connection is maintained between the terminal equipment and the network equipment, for processing communication with the network equipment.

On the other hand, the thus illustrated apparatus 10 may represent or realize/embody a (part of a) a network equipment. Specifically, the thus illustrated apparatus 10 may be configured to perform a procedure and/or exhibit a functionality and/or implement a state diagram, as described, for the network equipment, in any one of FIGS. 2 to 6.

Accordingly, the apparatus 10 may be caused or the apparatus 10 or its processor 11 (possibly together with computer program code stored in the memory 12), in its most basic form, is configured to operate in a connected mode, in which a data plane connection and a control plane connection are established between a terminal equipment and a network equipment and context information for the terminal equipment is established, for processing communication with the terminal equipment, to transition from the connected mode to an inactive mode upon data plane inactivity, and to operat in the inactive mode, in which the data plane connection is released and the control plane connection is maintained between the terminal equipment and the network equipment and the context information for the terminal equipment is maintained, for processing communication with the terminal equipment.

As mentioned above, any apparatus according to exemplifying embodiments of the present invention may be structured by comprising respective units or means for performing corresponding operations, procedures and/or functions. For example, such units or means may be implemented/realized on the basis of an apparatus structure, as exemplified in FIG. 7, i.e. by one or more processors 11, one or more memories 12, one or more communicators 13, or any combination thereof.

FIG. 8 shows a schematic diagram illustrating another example of a structure of apparatuses according to exemplifying embodiments of the present invention.

As shown in FIG. 8, an apparatus 100 according to exemplifying embodiments of the present invention may comprise (at least) a unit or means for operating in a connected mode for processing communication between a terminal equipment and a network equipment (denoted as connected mode operating unit/means 110), a unit or means for transitioning from the connected mode to an inactive mode (denoted as transition unit/means 140), and a unit or means for operating in the inactive mode for processing communication between the terminal equipment and the network equipment (denoted as inactive mode operating unit/means 120).

As shown in FIG. 8, the apparatus 100 according to exemplifying embodiments of the present invention may comprise (at least) a unit or means for operating in the idle mode for processing communication between the terminal equipment and the network equipment (denoted as idle mode operating means 130). The transition unit/means 140 may be further adapted/configured for a transition from the inactive mode to the idle mode and/or for a transition from the idle mode to the connected mode. Still further, the apparatus 100 according to exemplifying embodiments of the present invention may comprise (at least) a unit or means for detecting at least one of data plane inactivity, control plane inactivity and actual or prospective data plane activity (not shown).

For further details regarding the operability/functionality of the individual apparatuses (or units/means thereof) according to exemplifying embodiments of the present invention, reference is made to the above description in connection with any one of FIGS. 2 to 6, respectively.

According to exemplifying embodiments of the present invention, any one of the processor, the memory and the communicator, as well as any one of the units/means, may be implemented as individual modules, chips, chipsets, circuitries or the like, or one or more of them can be implemented as a common module, chip, chipset, circuitry or the like, respectively.

According to exemplifying embodiments of the present invention, a system may comprise any conceivable combination of the thus depicted devices/apparatuses and other network elements, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or units/means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for enabling/realizing an inactive communication mode, namely an inactive mode for the operation of terminal equipment and network equipment in a communication system. Such measures exemplarily comprise operation in a connected mode, in which a data plane connection and a control plane connection are established between a terminal equipment and a network equipment, transition from the connected mode to an inactive mode upon data plane inactivity, and operation in the inactive mode, in which the data plane connection is released and the control plane connection is maintained between the terminal equipment and the network equipment.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

### LIST OF ACRONYMS AND ABBREVIATIONS

3GPP 3rd Generation Partnership Project

AP Access Point

CN Core Network

DRB Dedicated (or Data) Radio Bearer

ECM EPS Connection Management

eNB enhanced Node B (LTE/LTE-A base station)

EPS Evolved Packet System

GW Gateway

LTE Long Term Evolution

LTE-A Long Term Evolution Advanced

MME Mobility Management Entity

MO Mobile Originated

MT Mobile Terminated

RAN Radio Access Network

RRC Radio resource Control

UE User Equipment

UMTS Universal Mobile Telecommunications System

UP User Plane

1.- 43. (canceled)

44. A method comprising:
operating in a connected mode, in which a data plane connection and a control plane connection are established between a terminal equipment and a network equipment, for processing communication with the network equipment,
transitioning from the connected mode to an inactive mode upon data plane inactivity, and
operating in the inactive mode, in which the data plane connection is released and the control plane connection is maintained between the terminal equipment and the network equipment, for processing communication with the network equipment.

45. The method according to claim 44, further comprising:
detecting the data plane inactivity when no communication of data plane traffic on the data plane connection is present for a data plane inactivity period.

46. The method according to claim 44, further comprising:
transitioning from the inactive mode to an idle mode upon control plane inactivity, and
operating in the idle mode, in which the data plane connection and the control plane connection are released between the terminal equipment and the network equipment, for processing communication with the network equipment.

47. The method according to claim 46, further comprising:
detecting the control plane inactivity when no communication of control plane traffic on the control plane connection is present for a control plane inactivity period.

48. The method according to claim 44, further comprising:
transitioning from the inactive mode to the connected mode upon actual or prospective data plane activity, and
operating in the connected mode, in which the data plane connection and the control plane connection are established between the terminal equipment and the network equipment, for processing communication with the network equipment.

49. The method according to claim 48, further comprising:
detecting the actual or prospective data plane activity when re-establishment of the data plane connection is initiated or requested by the terminal equipment or the network equipment, or when data plane traffic requiring re-establishment of the data plane connection is pending at the terminal equipment.

50. The method according to claim 44, wherein operating in the inactive mode comprises:
performing handover or reselection from a former network equipment to a recent network equipment within a network equipment cluster comprising the network equipment, whose control plane connection with the terminal equipment is maintained in transitioning from the connected mode to the inactive mode, and/or
notifying information indicative of at least one of location and serving network equipment of the terminal equipment to a network equipment within a network equipment cluster comprising the network equipment, whose control plane connection with the terminal equipment is maintained in transitioning from the connected mode to the inactive mode.

51. The method according to claim 44, wherein, in the inactive mode,
a data plane connection and/or a control plane connection between the network equipment and a core network element, which are established in the connected mode, are maintained, or
a data plane connection and/or a control plane connection between the network equipment and a core network element, which are established in the connected mode, are released.

52. The method according to claim 44, wherein
the method is operable at or by the terminal equipment or a core network element, or
the terminal equipment comprises a user equipment, or
the network equipment comprises a radio access element or a radio access controller, or
the data plane connection comprises a user plane bearer, or
the control plane connection comprises a signaling connection.

53. A method comprising:
operating in a connected mode, in which a data plane connection and a control plane connection are established between a terminal equipment and a network equipment and context information for the terminal equipment is established, for processing communication with the terminal equipment,
transitioning from the connected mode to an inactive mode upon data plane inactivity, and
operating in the inactive mode, in which the data plane connection is released and the control plane connection is maintained between the terminal equipment and the network equipment and the context information for the terminal equipment is maintained, for processing communication with the terminal equipment.

54. The method according to claim 53, wherein operating in the inactive mode comprises:
tracking information indicative of at least one of location and serving network equipment of the terminal equipment within a network equipment cluster comprising the network equipment, whose control plane connection with the terminal equipment is maintained and which maintains the context information for the terminal equipment in transitioning from the connected mode to the inactive mode, or
shifting the maintained context information for the terminal equipment to a recent network equipment serving the terminal equipment when the recent network equipment is not within a network equipment cluster comprising the network equipment, whose control plane connection with the terminal equipment is maintained and which maintains the context information for the terminal equipment in transitioning from the connected mode to the inactive mode, or when establishment of a new data plane connection between the terminal equipment and the recent network equipment is required.

55. The method according to claim 53, wherein operating in the inactive mode comprises:
maintaining a data plane connection and/or a control plane connection between the network equipment and a core network element, which are established in the connected mode, and
switching the maintained data plane connection and/or control plane connection to a recent network equipment serving the terminal equipment upon handover or reselection of the terminal equipment from a former network equipment to the recent network equipment.

56. The method according to claim 53, wherein operating in the inactive mode comprises:
releasing a data plane connection and/or a control plane connection between the network equipment and a core network element, which are established in the connected mode.

57. The method according to claim 53, wherein
the method is operable at or by the network equipment, or
the terminal equipment comprises a user equipment, or
the network equipment comprises a radio access element or a radio access controller, or
the data plane connection comprises a user plane bearer, or
the control plane connection comprises a signaling connection.

58. An apparatus comprising:
a processor, and
a memory configured to store computer program code,
wherein the processor is configured to cause the apparatus to perform:
operating in a connected mode, in which a data plane connection and a control plane connection are established between a terminal equipment and a network equipment, for processing communication with the network equipment,
transitioning from the connected mode to an inactive mode upon data plane inactivity, and
operating in the inactive mode, in which the data plane connection is released and the control plane connection is maintained between the terminal equipment and the network equipment, for processing communication with the network equipment.

59. An apparatus comprising:
a processor, and
a memory configured to store computer program code,
wherein the processor is configured to cause the apparatus to perform:
operating in a connected mode, in which a data plane connection and a control plane connection are established between a terminal equipment and a network equipment and context information for the terminal equipment is established, for processing communication with the terminal equipment,
transitioning from the connected mode to an inactive mode upon data plane inactivity, and
operating in the inactive mode, in which the data plane connection is released and the control plane connection is maintained between the terminal equipment and the network equipment and the context information for the terminal equipment is maintained, for processing communication with the terminal equipment.

60. A computer program product embodied on a non-transitory computer-readable medium, said product comprising computer-executable computer program code which, when the computer program code is executed on a computer, is configured to cause the computer to carry out the method according to claim 44.
